(19) United States
(12) Patent Application Publication
(10) Pub. No.: US 2016/0134804 A1
(43) Pub. Date: May 12, 2016

(54) IMAGE CAPTURE METHODS AND SYSTEMS

(71) Applicant: Noodoe Corporation, Taipei City (TW)

(72) Inventors: John C. Wang, Taipei City (TW); Chieh Yang, Taipei City (TW); Ying-Chieh Hu, Taipei City (TW)

(21) Appl. No.: 14/930,733

(22) Filed: Nov. 3, 2015

(30) Foreign Application Priority Data
Nov. 12, 2014 (TW) 103139170

(51) Int. Cl. H04N 5/232

(52) U.S. Cl. CPC H04N 5/23222; H04N 5/23206; H04N 5/23229; H04W 84/18

(57) ABSTRACT

Image capture methods and systems are provided. First, at least one identification data is received from at least one wearable electronic device via a wireless network, wherein the wearable electronic device actively broadcasts its identification data via the wireless network. Then, an image is captured using an image capture unit of an electronic device. When the image is captured, the at least one identification data and the image are associated, and the identification data and the image are automatically transmitted to a server via a network.

### BACKGROUND OF THE INVENTION

1. Field of the Invention

The disclosure relates generally to image capture methods and systems, and, more particularly to methods and systems that can generate identification data during image capturing, and automatically transmit the captured image and the corresponding identification data to a cloud service for storage and access via a network.

2. Description of the Related Art

Recently, electronic devices, such as smart phones, tablets, notebooks, and other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

Portable devices are also typically equipped with at least one image capture unit. Users can use the portable device to perform a photographic process for portraits or landscapes via the image capture unit. Today, the camera function is perceived as one of the most important functions in the portable devices such as smart phones.

Generally, a user can perform a selfie using a portable device, thus making the user become the protagonist of the photo. However, in some cases, the user cannot personally operate the portable device to perform the photographic process. For example, when a user rides a motorcycle or joins a race such as a marathon, the user may would like to be featured as the protagonist in the photos. The user would like to have photos of the user riding a motorcycle, or the user running during a marathon. However, the user cannot personally operate the portable device to perform the photographic process in these cases. Traditionally, this problem has been solved by organization hosting a race. They can invite press or photographers to perform the photographic process for players. After the race, the organization uploads the photos to a website, and the players can view and download their own photos. In this conventional model, since the number of press representatives or photographers is limited, the photos rarely cover all of the players who participated in the race. This problem becomes even bigger in races with a large number participants. Additionally, when other photographers who are not invited by the organization join the photographic process, related photos are difficult to obtain or manage.

Furthermore, the conventional management of photos is performed manually. For example, related personnel must manually inspect the number on the bibs in the respective photos, and accordingly determine the owner of the respective photos. The conventional management of photos is painstaking, complicated, and time-consuming for the organization. Also, the players won't be able to find and enjoy until several days after the event. The conventional mechanism is therefore lacking, inefficient and in need of a major improvement.

### BRIEF SUMMARY OF THE INVENTION

Image capture methods and systems are provided, wherein identification data can be generated during image capturing, and the captured image and the corresponding identification data can be automatically transmitted to a cloud service for storage and access via a network.

In an embodiment of an image capture method, at least one identification data is received from at least one wearable electronic device via a wireless network, wherein the wearable electronic device actively broadcasts its identification data via the wireless network. Then, an image is captured using an image capture unit of an electronic device. When the image is captured, at least one identification data and the image are associated, and the at least one identification data and the image are automatically transmitted to a server via a network.

An embodiment of an image capture system comprises a wireless connecting unit, an image capture unit, a network connecting unit, and a processing unit. The wireless connecting unit receives at least one identification data from at least one wearable electronic device via a wireless network, wherein the wearable electronic device actively broadcasts its identification data via the wireless network. The image capture unit captures an image. The processing unit associates at least one identification data with the image, and automatically transmits the identification data and the image to a server via a network by using the network connecting unit.

In some embodiments, when a plurality of identification data is obtained, the image is simultaneously associated to the respective identification data.

In some embodiments, it is determined whether the time when at least one identification data is received and the time when the image is captured are within a predefined interval. If the time when at least one identification data is received and the time when the image is captured are within the predefined interval, then the identification data and the image are associated.

In some embodiments, at least one auxiliary identification data is received, and the at least one auxiliary identification data is associated with the image. In this case, the auxiliary identification data, the identification data, and the image are automatically transmitted to the server via the network.

In some embodiments, a user interface is provided to receive an input corresponding to the at least one auxiliary identification data.

In some embodiments, at least one number in the image is analyzed using an image recognition technology, and the analyzed number is set as the auxiliary identification data.

In some embodiments, location information is obtained, and the location information is set as the auxiliary identification data. In some embodiments, the location information is broadcasted by a specific electronic device via a wireless network, or the location information is obtained from a positioning unit of the electronic device.

In some embodiments, at least one sensing data is received from the wearable electronic device via the wireless network, wherein the wearable electronic device has at least one sensor for generating the sensing data. The sensing data is associated with the image, and the sensing data, the identification data, and the image are automatically transmitted to the server via the network.

In some embodiments, the electronic device can execute a specific application, wherein the specific application records a network address corresponding to the server. The specific application automatically transmits the at least one identification data and the image to the server via the network according to the network address.

In some embodiments, when the identification data is received from the wearable electronic device, the image capture unit of the electronic device is automatically triggered to capture the image.

In some embodiments, a user interface is provided by the server to receive an input corresponding to the at least one identification data. The server retrieves the image associated with the identification data according to the at least one identification data received via the user interface.

Image capture methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image capture system of the invention;

FIG. 2 is a schematic diagram illustrating an embodiment of an electronic device of the invention;

FIG. 3 is a flowchart of an embodiment of an image capture method of the invention;

FIG. 4 is a flowchart of another embodiment of an image capture method of the invention;

FIG. 5 is a flowchart of another embodiment of an image capture method of the invention;

FIG. 6 is a flowchart of an embodiment of a method for obtaining auxiliary identification data of the invention;

FIG. 7 is a flowchart of another embodiment of a method for obtaining auxiliary identification data of the invention;

FIG. 8 is a flowchart of another embodiment of a method for obtaining auxiliary identification data of the invention;

FIG. 9 is a flowchart of an embodiment of a method for obtaining an image of the invention;

FIG. 10 is a flowchart of another embodiment of a method for obtaining an image of the invention;

FIG. 11 is a schematic diagram illustrating an example of image capturing of the invention;

FIG. 12 is a schematic diagram illustrating an example of an image integrated with sensing data of the invention; and

FIGS. 13A and 13B are schematic diagrams illustrating an example of image retrieval of the invention.

### DETAILED DESCRIPTION OF THE INVENTION

Image capture methods and systems are provided.

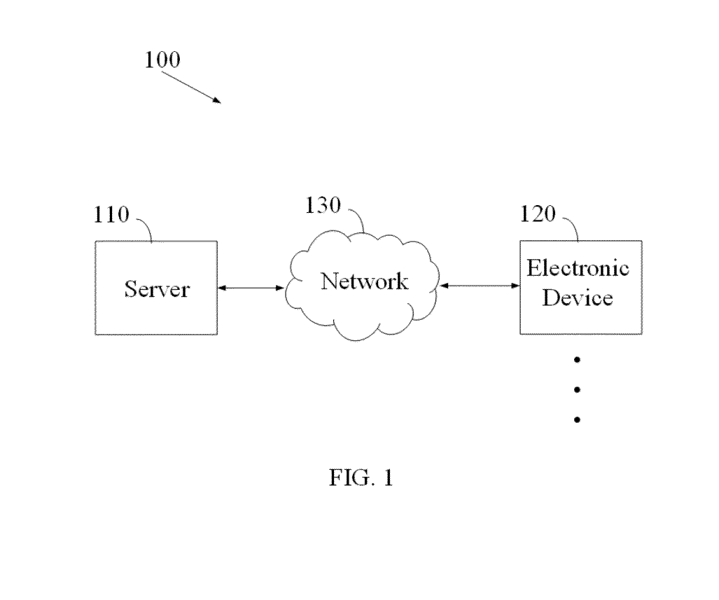

FIG. 1 is a schematic diagram illustrating an embodiment of an image capture system of the invention. The image capture system 100 comprises a server 110 and at least one electronic device 120. In some embodiments, the electronic device 120 may be any electronic device having network connectivity and image capture capabilities, such as a camera, a mobile phone, a smart phone, a PDA (Personal Digital Assistant), a GPS (Global Positioning System), a wearable electronic device, a notebook, a tablet computer, or other portable device. It is noted that, the electronic device 120 can connect to the server 110 via a network 130, such as a wired network, a wireless network, and/or a telecommunication network. It is understood that, in some embodiments, the electronic device 120 can execute a specific application, wherein the specific application records a network address corresponding to the server 110.

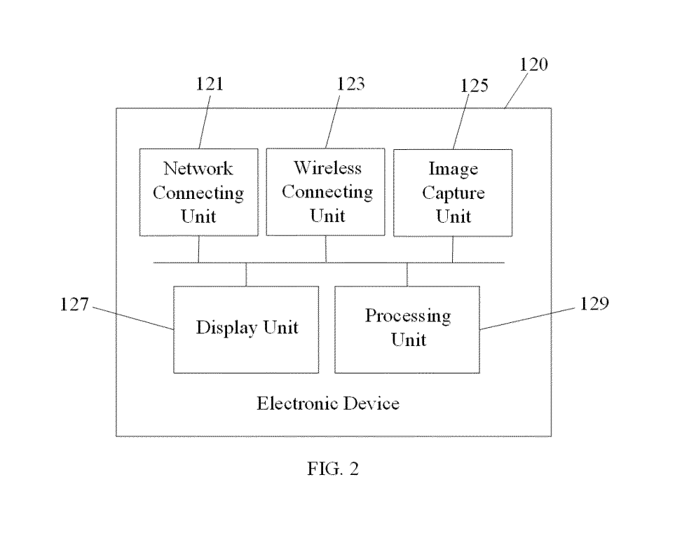

FIG. 2 is a schematic diagram illustrating an embodiment of an electronic device of the invention. As shown in FIG. 2, the electronic device 120 comprises a network connecting unit 121, a wireless connecting unit 123, an image capture unit 125, a display unit 127, and a processing unit 129. The network connecting unit 121 can connect to a network, such as a wired network, a wireless network, and/or a telecommunication network, in order to access the Internet. The electronic device 120 can have network connectivity capabilities by using the network connecting unit 121. The wireless connecting unit 123 can connect to other electronic devices having wireless connecting capabilities via a wireless network, such as Wi-Fi or Bluetooth network. For example, the wireless connecting unit 123 can detect and receive wireless signals transmitted by a specific electronic device, such as a wearable electronic device or a beacon device via a Bluetooth network. The image capture unit 125 may be a CCD (Charge Coupled Device) or a CMOS (Complementary Metal-Oxide Semiconductor), placed at the imaging position for objects inside the device. The display unit 127 can display related information, such as images captured by the image capture unit 125, interfaces, and/or related data. The processing unit 129 can control related operations of hardware and software in the electronic device 120, and perform the image capture methods of the invention. This will be discussed further in the following paragraphs. It is understood that, in some embodiments, the electronic device 120 can further comprise a sound output unit (not shown in FIG. 2) for generating sounds. In some embodiments, the electronic device 120 can further comprise a vibration unit (not shown in FIG. 2) for generating vibrations.

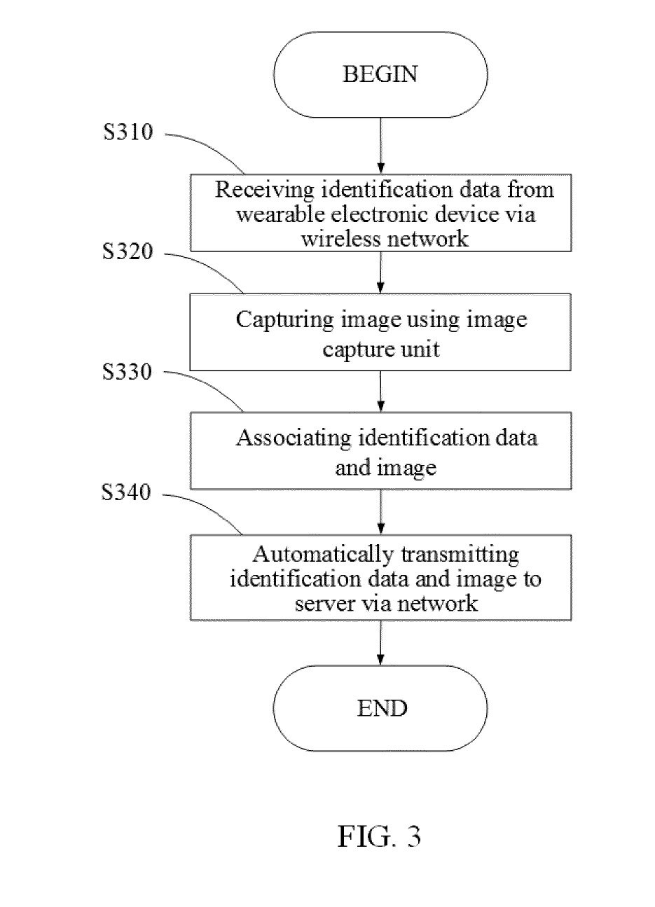

FIG. 3 is a flowchart of an embodiment of an image capture method of the invention. The image capture method can be used in any electronic device having network connectivity and image capture capabilities, such as a camera, a mobile phone, a smart phone, a PDA, a GPS, a wearable electronic device, a notebook, a tablet computer, or other portable device.

In step S310, at least one identification data is received from at least one wearable electronic device via a wireless network, such as Wi-Fi or Bluetooth network. As described, a wireless connecting unit of the electronic device can detect and receive wireless signals transmitted by a specific electronic device, such as a wearable electronic device or a beacon device via a wireless network. It is noted that, the wearable electronic device actively broadcasts its identification data via the wireless network. Then, in step S320, an image is captured using an image capture unit of the electronic device. It is understood that, in some embodiments, when the identification data is received from the wearable electronic device, the image capture unit of the electronic device is automatically triggered to capture the image. It is understood that, in some embodiments, the order of steps S310 and S320 can be changed. In other words, in some embodiments, the image can be first captured, and the identification data is received. When the image is captured, in step S330, the at least one identification data and the image are associated. It is noted that, in some embodiments, when a plurality of identification data is obtained, the image is simultaneously associated to the respective identification data. It is understood that, in some embodiments, it is determined whether the time when the at least one identification data is received and the time when the image is captured are within a predefined interval. If the time when the at least one identification data is received and the time when the image is captured are within the predefined interval, the at least one identification data and the image are associated. Then, in step S340, the identification data and the image are automatically transmitted to a server via a network. It is understood that, in some embodiments, the electronic device can execute a specific application, wherein the specific application records a network address corresponding to the server. The specific application automatically transmits the identification data and the image to the server via the network according to the network address.

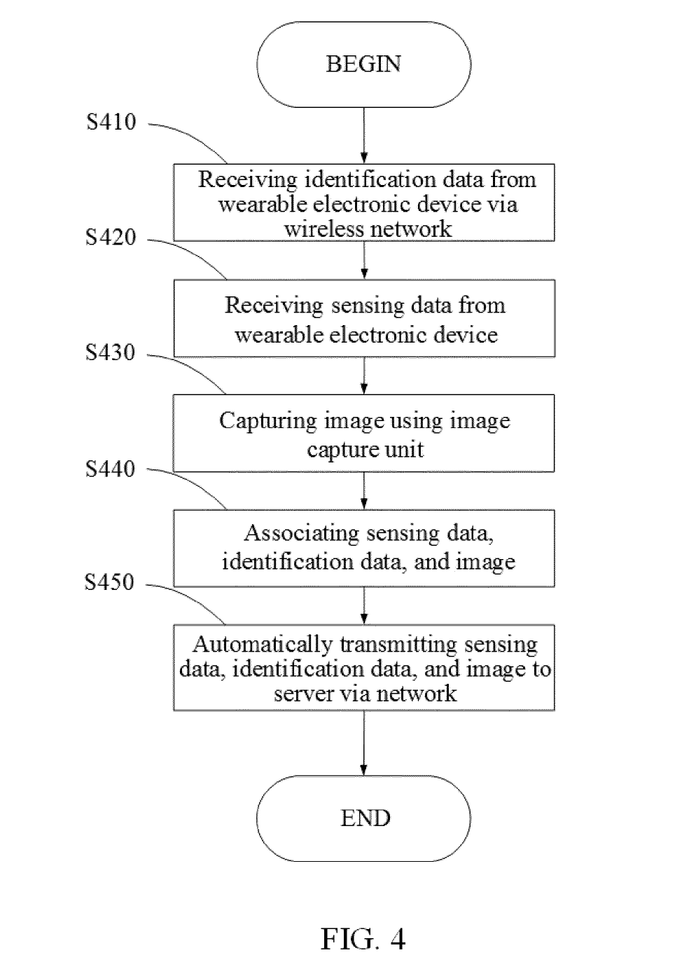

FIG. 4 is a flowchart of another embodiment of an image capture method of the invention. The image capture method can be used in any electronic device having network connectivity and image capture capabilities, such as a camera, a mobile phone, a smart phone, a PDA, a GPS, a wearable electronic device, a notebook, a tablet computer, or other portable device.

In step S410, at least one identification data is received from at least one wearable electronic device via a wireless network, such as Wi-Fi or Bluetooth network. Similarly, a wireless connecting unit of the electronic device can detect and receive wireless signals transmitted by a specific electronic device, such as a wearable electronic device or a beacon device via a wireless network. It is noted that, the wearable electronic device actively broadcasts its identification data via the wireless network. Then, in step S420, at least one sensing data is received from the wearable electronic device via the wireless network. It is noted that, the wearable electronic device has at least one sensor for generating the sensing data. For example, the sensor may be a heart rate monitor sensor for detecting the heart rate of a user wearing the wearable electronic device. Then, in step S430, an image is captured using an image capture unit of the electronic device. It is understood that, in some embodiments, when the identification data is received from the wearable electronic device, the image capture unit of the electronic device is automatically triggered to capture the image. It is understood that, in some embodiments, the order of steps S410, S420 and S430 can be changed. For example, in some embodiments, the image can be first captured, and the identification data and the sensing data are received later. When the image is captured, in step S440, the at least one sensing data, the at least one identification data, and the image are associated. Similarly, in some embodiments, when a plurality of identification data is obtained, the image is simultaneously associated to the respective identification data. Similarly, in some embodiments, it is determined whether the time when the at least one identification data is received and the time when the image is captured are within a predefined interval. If the time when the at least one identification data is received and the time when the image is captured are within the predefined interval, the at least one identification data and the image are associated. Then, in step S450, the sensing data, the identification data, and the image are automatically transmitted to a server via a network. Similarly, in some embodiments, the electronic device can execute a specific application, wherein the specific application records a network address corresponding to the server. The specific application automatically transmits the sensing data, the identification data, and the image to the server via the network according to the network address.

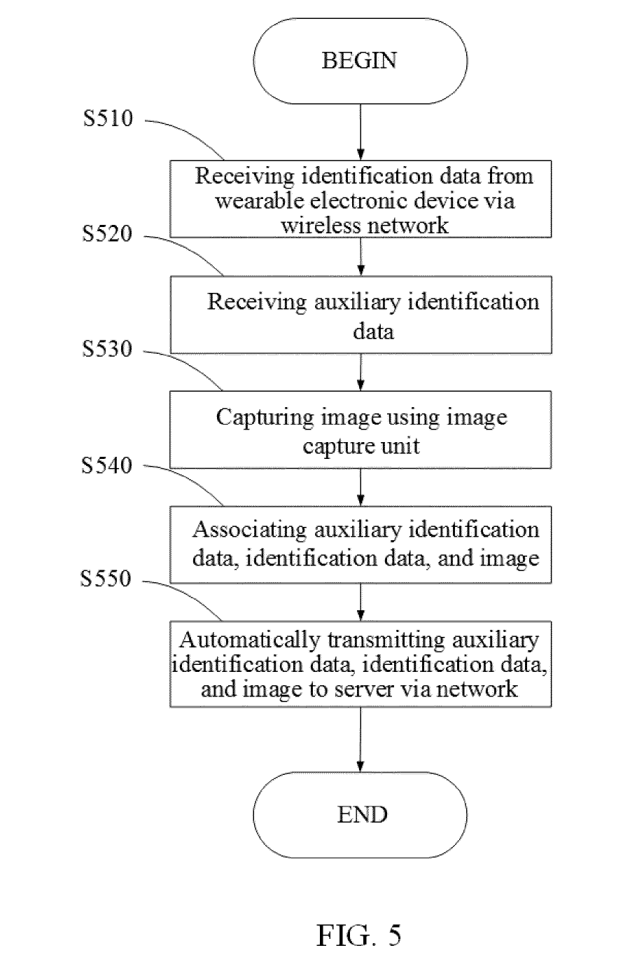

FIG. 5 is a flowchart of another embodiment of an image capture method of the invention. The image capture method can be used in any electronic device having network connectivity and image capture capabilities, such as a camera, a mobile phone, a smart phone, a PDA, a GPS, a wearable electronic device, a notebook, a tablet computer, or other portable device.

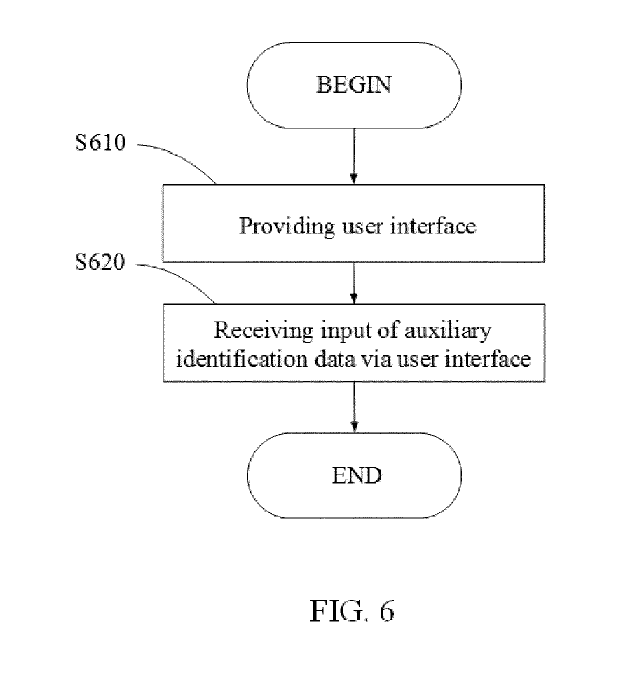

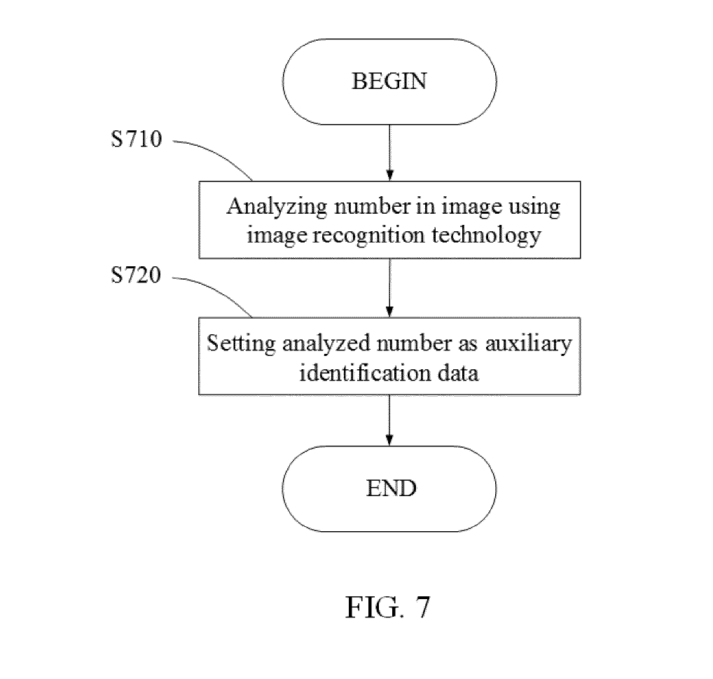

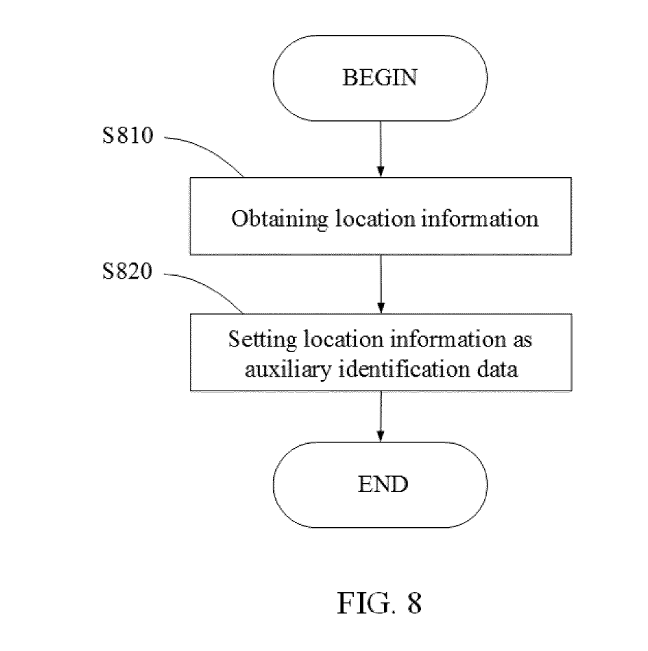

In step S510, at least one identification data is received from at least one wearable electronic device via a wireless network, such as Wi-Fi or Bluetooth network. Similarly, a wireless connecting unit of the electronic device can detect and receive wireless signals transmitted by a specific electronic device, such as a wearable electronic device or a beacon device via a wireless network. It is noted that, the wearable electronic device actively broadcasts its identification data via the wireless network. Then, in step S520, at least one auxiliary identification data is received. FIG. 6 is a flowchart of an embodiment of a method for obtaining auxiliary identification data of the invention. In step S610, a user interface is provided. In step S620, an input corresponding to the auxiliary identification data is received via the user interface. FIG. 7 is a flowchart of another embodiment of a method for obtaining auxiliary identification data of the invention. In step S710, at least one number in the image is analyzed using an image recognition technology, and in step S720, the analyzed number is set as auxiliary identification data. FIG. 8 is a flowchart of another embodiment of a method for obtaining auxiliary identification data of the invention. In step S810, location information is obtained, and in step S820, the location information is set as auxiliary identification data. It is understood that, in some embodiments, the location information is broadcasted by a specific electronic device via a wireless network. For example, a beacon device can record the location information, and the location information is wirelessly broadcasted. The electronic device can receive the location information from the beacon device via a wireless network by using the wireless connecting unit. Additionally, in some embodiments, the location information can be obtained from a positioning unit of the electronic device. For example, the electronic device can have a GPS, which can communicate with at least one satellite to know the location information of the electronic device. It is understood that, the above manners for obtaining the auxiliary identification data are only examples of the present application, and the present invention is not limited thereto. After the at least one auxiliary identification data is received, in step S530, an image is captured using an image capture unit of the electronic device. It is understood that, in some embodiments, when the identification data is received from the wearable electronic device, the image capture unit of the electronic device is automatically triggered to capture the image. It is understood that, in some embodiments, the order of steps S510, S520 and S530 can be changed. For example, in some embodiments, the image can be first captured, and the identification data and the auxiliary identification data are received. When the image is captured, in step S540, the at least one auxiliary identification data, the at least one identification data, and the image are associated. Similarly, in some embodiments, when a plurality of identification data is obtained, the image is simultaneously associated to the respective identification data. Similarly, in some embodiments, it is determined whether the time when the identification data is received and the time when the image is captured are within a predefined interval. If the time when the at least one identification data is received and the time when the image is captured are within the predefined interval, the at least one identification data and the image are associated. Then, in step S550, the auxiliary identification data, the identification data, and the image are automatically transmitted to a server via a network. Similarly, in some embodiments, the electronic device can execute a specific application, wherein the specific application records a network address corresponding to the server. The specific application automatically transmits the auxiliary identification data, the identification data, and the image to the server via the network according to the network address. It is understood that, in some embodiments, the wearable electronic device may have at least one sensor, such as a heart rate monitor sensor for generating at least one sensing data. The electronic device can receive the sensing data from the wearable electronic device via a wireless network. The electronic device can associate the sensing data with the image, and automatically transmit the sensing data, the identification data, and the image to the server via the network.

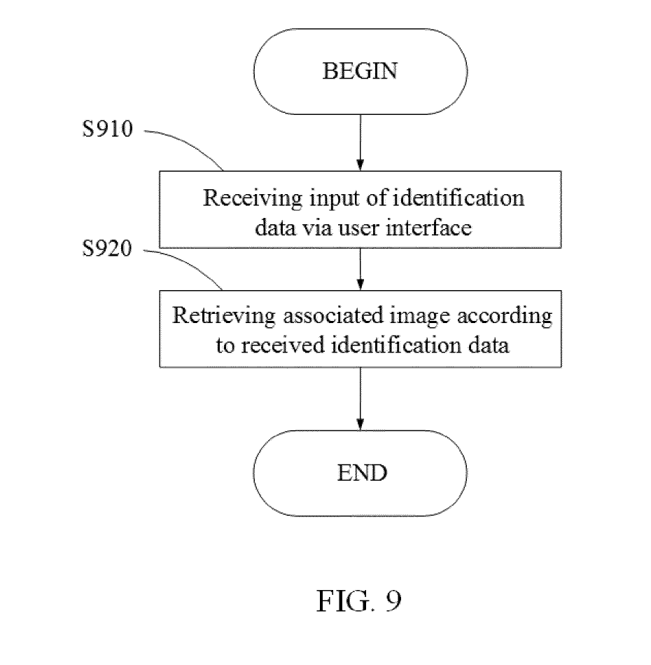

FIG. 9 is a flowchart of an embodiment of a method for obtaining an image of the invention. The method for obtaining an image can be used in any processor-based electronic device, such as a personal computer, a notebook, a tablet computer, or a server.

In step S910, a user interface is provided by the electronic device, and an input corresponding to at least one identification data is received via the user interface. It is understood that, in some embodiments, the electronic device can automatically detect and receive at least one identification data from a specific electronic device via a wireless network. In step S920, at least one image associated with at least one identification data is retrieved according to the identification data received via the user interface. It is understood that, in some embodiments, the retrieved image can be displayed, and/or transmitted to the specific electronic device via a network.

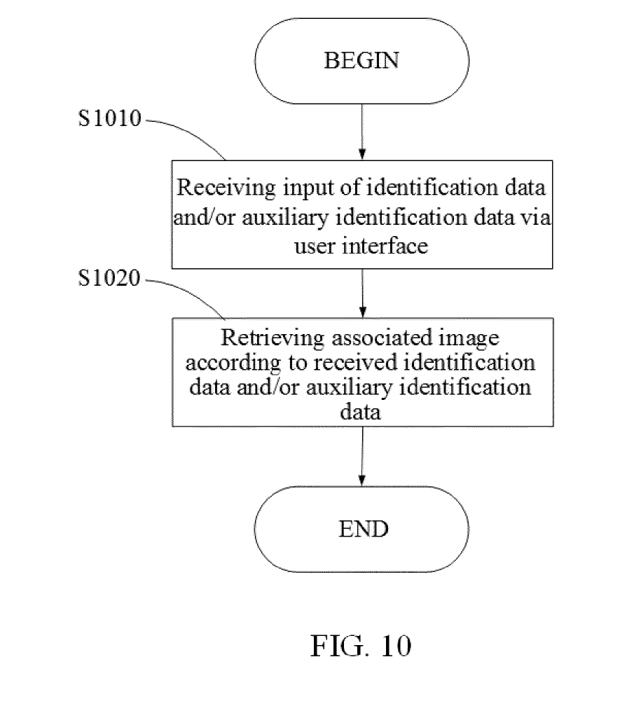

FIG. 10 is a flowchart of another embodiment of a method for obtaining an image of the invention. The method for obtaining an image can be used in any processor-based electronic device, such as a personal computer, a notebook, a tablet computer, or a server.

In step S910, a user interface is provided by the electronic device, and an input corresponding to at least one identification data and/or at least one auxiliary identification data is received via the user interface. It is understood that, in some embodiments, the electronic device can automatically detect and receive at least one identification data from a specific electronic device via a wireless network. In some embodiments, the auxiliary identification data may be a specific number, and/or a specific location information. In step S1020, at least one image associated with at least one identification data and/or at least one auxiliary identification data is retrieved according to the identification data and/or the auxiliary identification data received via the user interface. Similarly, in some embodiments, the retrieved image can be displayed, and/or transmitted to the specific electronic device via a network.

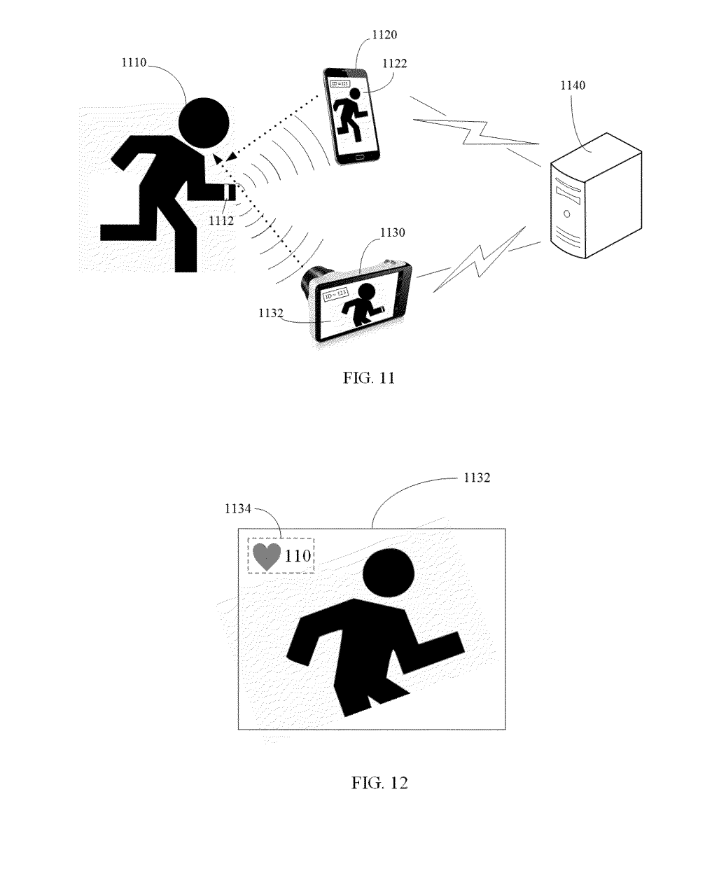

FIG. 11 is a schematic diagram illustrating an example of image capturing of the invention. As shown in FIG. 11, a runner 1110 wearing a wearable electronic device 1112 joins a marathon. The wearable electronic device 1112 actively broadcasts the identification data “ID=123” corresponding to the runner 1110 via a wireless network. At this time, a smart phone 1120 of a user A who is watching the race can detect the identification data “ID=123” corresponding to the runner 1110 via the wireless network, and the user A can use the smart phone 1120 to perform a photographic process for the runner 1110 to generate a photo 1122. After the photographic process, the smart phone 1120 automatically associates the identification data “ID=123” with the photo 1122, and transmits the identification data “ID=123” and the photo 1122 to a server 1140 via a network. Also, a camera 1130 of a user B who is watching the race can also detect the identification data “ID=123” corresponding to the runner 1110 via the wireless network, and the user B can use the camera 1130 to perform a photographic process for the runner 1110 to generate a photo 1132. Similarly, after the photographic process, the camera 1130 automatically associates the identification data “ID=123” with the photo 1132, and transmits the identification data “ID=123” and the photo 1132 to the server 1140 via the network. It is understood that, in some embodiments, the smart phone 1120 and the camera 1130 can respectively execute a specific application. Users can select the marathon race via the specific application. When the marathon race is selected, all photos will be transmitted to a server corresponding to the marathon race or a specific address in the server via a network.

In some cases, the wearable electronic device 1112 can have at least one sensor, such as a hear rate monitor sensor for detecting the heart rate corresponding to the runner 1110. The wearable electronic device 1112 can actively broadcast the heart rate corresponding to the runner 1110 via a wireless network. The smart phone 1120 and the camera 1130 can respectively receive the heart rate corresponding to the runner 1110 from the wearable electronic device 1112 via the wireless network, and associate the heart rate with the photo and the corresponding identification data. The runner 1110 can obtain the heart rate of the runner 1110 at the time that the photo is taken from the photo. In some cases, the heart rate 1134 can be presented on the photo 1132, as shown in FIG. 12.

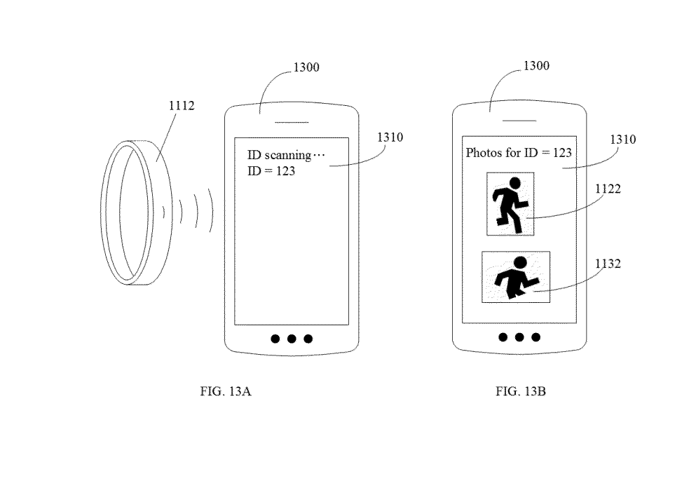

FIGS. 13A and 13B are schematic diagrams illustrating an example of image retrieval of the invention. After the runner 1110 completes the marathon race, the runner 1110 can move the wearable electronic device 1112 close to a specific electronic device 1300, such as a smart phone of the runner 1110 or a machine provided by the organization of the marathon race. The specific electronic device 1300 can detect the identification data “ID=123” of the wearable electronic device 1112 via a wireless network, and display the identification data “ID=123” via a user interface 1310. The specific electronic device 1300 can transmit the identification data “ID=123” to the server 1140, and the server 1140 can retrieve photos associated with the identification data “ID=123”. When the associated photos 1122 and 1132 are retrieved, the server 1140 can transmit the photos 1122 and 1132 to the specific electronic device 1300 for display via the network. In some embodiments, the runner 1110 can store the photos 1122 and 1132.

Therefore, the image capture methods and systems of the present invention can generate identification data during image capturing, and automatically transmit the captured image and the corresponding identification data to a cloud service for storage and access via a network, thereby improving the management of photos, and increasing the efficiency of viewing and downloading of photos.

Image capture methods may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An image capture method for use in an electronic device, comprising:
receiving at least one identification data from at least one wearable electronic device via a wireless network, wherein the wearable electronic device actively broadcasts its identification data via the wireless network;
capturing an image using an image capture unit of the electronic device;
associating the at least one identification data and the image; and
automatically transmitting the identification data and the image to a server via a network.

2. The method of claim 1, wherein when a plurality of identification data is obtained, the image is simultaneously associated to the respective identification data.

3. The method of claim 1, further comprising:
determining whether the time when the at least one identification data is received and the time when the image is captured are within a predefined interval; and
if the time when the at least one identification data is received and the time when the image is captured are within the predefined interval, associating the identification data and the image.

4. The method of claim 1, further comprising:
receiving at least one auxiliary identification data;
associating the at least one auxiliary identification data with the image; and
automatically transmitting the auxiliary identification data, the identification data, and the image to the server via the network.

5. The method of claim 4, further comprising a step of providing a user interface to receive an input corresponding to the at least one auxiliary identification data.

6. The method of claim 4, further comprising:
analyzing at least one number in the image using an image recognition technology; and
setting the analyzed number as the at least one auxiliary identification data.

7. The method of claim 4, further comprising:
obtaining location information; and
setting the location information as the at least one auxiliary identification data.

8. The method of claim 7, wherein the location information is broadcasted by a specific electronic device via a wireless network, or the location information is obtained from a positioning unit of the electronic device.

9. The method of claim 1, further comprising:
receiving at least one sensing data from the wearable electronic device via the wireless network, wherein the wearable electronic device has at least one sensor for generating the sensing data;
associating the sensing data with the image; and
automatically transmitting the sensing data, the identification data, and the image to the server via the network.

10. The method of claim 1, wherein the electronic device further executes a specific application, wherein the specific application records a network address corresponding to the server, and the specific application automatically transmits the identification data and the image to the server via the network according to the network address.

11. The method of claim 1, wherein when the identification data is received from the wearable electronic device, the image capture unit of the electronic device is automatically triggered to capture the image.

12. The method of claim 1, further comprising:
providing a user interface by the server to receive an input corresponding to the at least one identification data; and
retrieving the image associated with the at least one identification data according to the at least one identification data received via the user interface by the server.

13. An image capture system for use in an electronic device, comprising:
a network connecting unit;
a wireless connecting unit receiving at least one identification data from at least one wearable electronic device via a wireless network, wherein the wearable electronic device actively broadcasts its identification data via the wireless network;
an image capture unit capturing an image; and
a processing unit associating the at least one identification data and the image, and automatically transmitting the identification data and the image to a server via a network by using the network connecting unit.

14. A machine-readable storage medium comprising a computer program, which, when executed, causes a device to perform an image capture method, wherein the method comprises:
receiving at least one identification data from at least one wearable electronic device via a wireless network, wherein the wearable electronic device actively broadcasts its identification data via the wireless network;
capturing an image using an image capture unit of the electronic device;
associating the at least one identification data and the image; and
automatically transmitting the identification data and the image to a server via a network.
